(19) United States
(12) Patent Application Publication
(10) Pub. No.: US 2020/0123790 A1
(43) Pub. Date: Apr. 23, 2020

(54) HIGH CAPACITY PLATFORMS AND CAGE MOUNT ASSEMBLIES

(71) Applicant: CommScope Technologies LLC, Hickory, NC (US)

(72) Inventor: Raphael de La Soujeole, Irving, TX (US)

(21) Appl. No.: 16/658,885

(22) Filed: Oct. 21, 2019

Related U.S. Application Data
(60) Provisional application No. 62/749,421, filed on Oct. 23, 2018.

(51) Int. Cl. E04G 3/24; E04G 5/08; E04G 5/14; H01Q 1/12; H01Q 9/30

(52) U.S. Cl. CPC E04G 3/243; E04G 5/08; H01Q 9/30; H01Q 1/1242; E04G 5/14

(57) ABSTRACT

The present disclosure describes a high capacity platform, the platform comprising a frame, the frame comprising an elongate, hollow main support member of rectangular cross-section, the main support member having a length, a width, and a height; and a plurality of elongate, hollow auxiliary support members attached orthogonally to the main support member, each auxiliary support member having a length, a width, and a height; a mounting plate coupled to an end of the main support member; at least two grating edge members coupled to the auxiliary support members; and a grating, wherein the grating is supported by the two grating edge members, the auxiliary support members, and the main support member. High capacity cage mount assemblies and platform assemblies are also described.

### RELATED APPLICATION(S)

The present application claims priority from and the benefit of U.S. Provisional Application Ser. No. 62/749,421, filed Oct. 23, 2018, the disclosure of which is hereby incorporated herein in its entirety.

### FIELD OF THE INVENTION

The present application is directed generally toward telecommunications equipment, and more particularly high capacity platforms and cage mount assemblies.

### BACKGROUND OF THE INVENTION

Various types of towers have been constructed for the purpose of supporting one or more antennas, such as those for broadcasting television and radio signals. Some towers are specifically designed for transmitting and receiving cellular telephone signals and other types of radio frequency (RF) signals. As wireless data service demands have grown, a conventional response has been to increase the number and capacity of conventional cellular Base Stations (Macro-Cells). Such Macro-Cells are typically mounted on antenna towers. A conventional antenna tower has three or four legs on which antennas and supporting remote radio units (RRUs) are mounted. However, in some environments structures known as “monopoles” are used as mounting structures. A typical monopole 10 with antennas 20 mounted on mounting frames 30 is shown in FIG. 1. Monopoles are typically employed when fewer antennas/RRUs are to be mounted, and/or when a structure of less height is required.

RF towers (including monopoles) are often designed to allow a person to climb to the top and remain there to install and/or repair RF antennas (e.g., cellular antennas) and other equipment connected to the tower. Platforms are typically mounted near the tops of RF towers (e.g., cellular towers) for supporting workers who may be responsible for installing and/or maintaining RF antennas (e.g., cellular antennas). Such platforms are designed to support the weight of a human and may also be used to support a number of the RF antennas. Exemplary platforms are described in U.S. Patent Publication No. 2011/0279347 to Pass et al., the disclosure of which is hereby incorporated herein in its entirety. The platform described in Pass et al. is a so-called “six-sector” platform.

Typically, monopole platforms use square or round standoff arms (like described in Pass et al.), which can make vertical loading the limiting factor. Some other known designs use a truss, which may result in significant welding, or significant waste material, if the standoff arm is cut out of a solid sheet or plate. Other designs use gussets, one on each side, which can increase manufacturing time and cost, and can result in a cavity where water can pool. There may be a need for a monopole platform which does not need gussets to strengthen it and allows for easy fabrication and more efficient installation, while reducing manufacturing costs.

### SUMMARY OF THE INVENTION

A first aspect of the present invention is directed to a high capacity platform, the platform comprising: a frame, the frame comprising: an elongate, hollow main support member of rectangular cross-section, the main support member having a length, a width, and a height; and a plurality of elongate, hollow auxiliary support members attached orthogonally to the main support member, each auxiliary support member having a length, a width, and a height; a mounting plate coupled to an end of the main support member; at least two grating edge members coupled to the auxiliary support members; and a grating, wherein the grating is supported by the two grating edge members, the auxiliary support members, and the main support member.

Another aspect of the present invention is directed to a high capacity cage mount assembly, comprising: (a) a cage mount, the cage mount comprising: (i) at least three top pipes, wherein the top pipes are oriented such that each top support pipe is coupled to two other top pipes; (ii) at least three bottom pipes, wherein the bottom pipes are oriented such that each bottom pipe is coupled to two other bottom pipes; and (iii) a plurality of spaced apart sidewall pipes, each sidewall pipe being orthogonally attached to a respective top and bottom pipe such that the top, bottom and sidewall pipes form a cage-like enclosure; (b) a plurality of platforms, each platform comprising: (i) a frame, the frame comprising: (1) an elongate, hollow support member of rectangular cross-section, the main support member having a length, a width, and a height; and (2) a plurality of elongate, hollow auxiliary support members attached orthogonally to the main support member, each auxiliary support member having a length, a width, and a height; (ii) a mounting plate coupled to an end of the main support member; (iii) at least two grating edge members coupled to the auxiliary support members; and (iv) a grating, wherein the grating is supported by the two grating edge members, the auxiliary support members, and the main support member; and (c) a plurality of top mounting brackets configured to be secured to a mounting structure; (d) a plurality of support braces, each support brace extending between and coupled to a top pipe and a top mounting bracket; and (e) a plurality of bottom mounting brackets configured to be secured to the mounting structure, wherein the auxiliary support members of each platform are configured to be secured to at least two of the bottom pipes of the cage mount and the mounting plate of each platform is configured to be secured to a respective bottom mounting bracket.

Another aspect of the present invention is directed to a high capacity platform assembly, the platform assembly comprising: a mounting structure; and at least three high capacity platforms, each platform comprising: a frame, the frame comprising: an elongate, hollow main support member of rectangular cross-section, the main support member having a length, a width, and a height; and a plurality of elongate, hollow auxiliary support members attached orthogonally to the main support member, each auxiliary support member having a length, a width, and a height; a mounting plate coupled to an end of the main support member and configured to be secured to the mounting structure; at least two grating edge members coupled to the auxiliary support members; and a grating, wherein the grating is supported by the two grating edge members, the auxiliary support members, and the main support member, wherein each platform is secured to the mounting structure by the mounting plate.

It is noted that aspects of the invention described with respect to one embodiment, may be incorporated in a different embodiment although not specifically described relative thereto. That is, all embodiments and/or features of any embodiment can be combined in any way and/or combination. Applicant reserves the right to change any originally filed claim and/or file any new claim accordingly, including the right to be able to amend any originally filed claim to depend from and/or incorporate any feature of any other claim or claims although not originally claimed in that manner. These and other objects and/or aspects of the present invention are explained in detail in the specification set forth below. Further features, advantages and details of the present invention will be appreciated by those of ordinary skill in the art from a reading of the figures and the detailed description of the preferred embodiments that follow, such description being merely illustrative of the present invention.

### BRIEF DESCRIPTION OF THE FIGURES

FIG. 1 is a front view of a conventional monopole with four antenna frames and accompanying antennas mounted thereon.

FIG. 2 is a rear perspective view of a high capacity platform according to embodiments of the present invention.

FIG. 3 is a rear perspective view of the frame of the platform of FIG. 2.

FIG. 4 is a top view of the frame of FIG. 3.

FIG. 5 is a side view of the platform of FIG. 2.

FIG. 6 is a top view of the platform of FIG. 2.

FIG. 7 is a perspective view of a high capacity cage mount assembly according to embodiments of the present invention that employs the high capacity platform of FIG. 2.

FIG. 8 is a perspective view of the high capacity cage mount assembly of FIG. 7 in combination with a mounting structure.

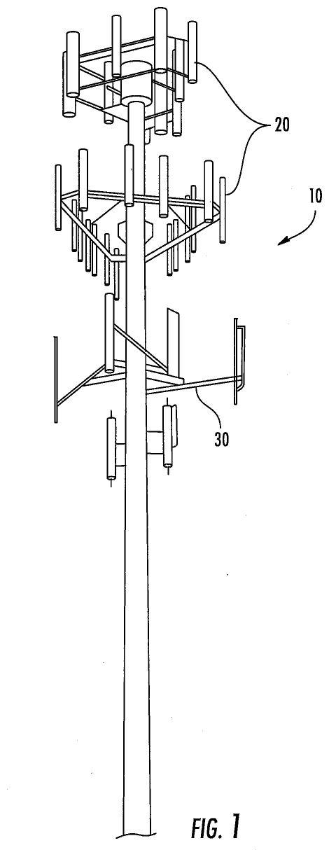

### DETAILED DESCRIPTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

The present invention now will be described more fully hereinafter with reference to the accompanying drawings, in which illustrative embodiments of the invention are shown.

In the figures, certain layers, components or features may be exaggerated for clarity, and broken lines illustrate optional features or operations unless specified otherwise. This invention may, however, be embodied in many different forms and should not be construed as limited to the embodiments set forth herein; rather, these embodiments are provided so that this disclosure will be thorough and complete, and will fully convey the scope of the invention to those skilled in the art.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention. The sequence of operations (or steps) is not limited to the order presented in the claims or figures unless specifically indicated otherwise.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

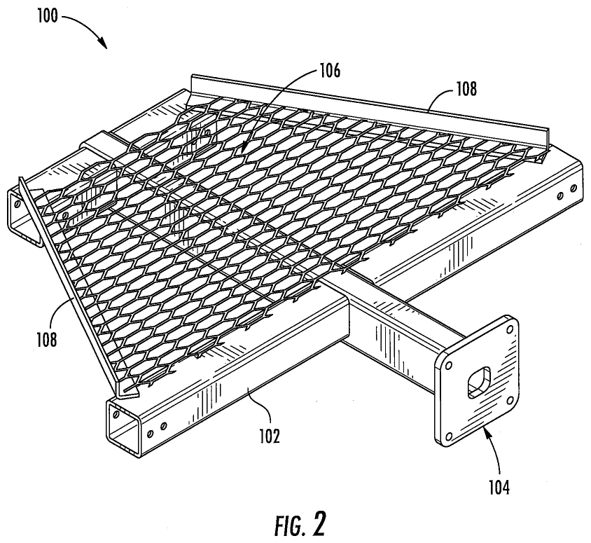

Referring now to the figures, a high capacity platform 100 according to some embodiments of the present invention is illustrated in FIGS. 2-6. As shown in FIG. 2, the platform 100 (or standoff) may comprise a frame 102, a mounting plate 104, a grating 106, and at least two grating edge members 108. In some embodiments, the platform 100 is formed of a weldment. In some embodiments, the platform 100 may comprise galvanized steel. In some embodiments, the high capacity platform 100 is configured to support a load weight of about 100 pound to about 3600 pounds.

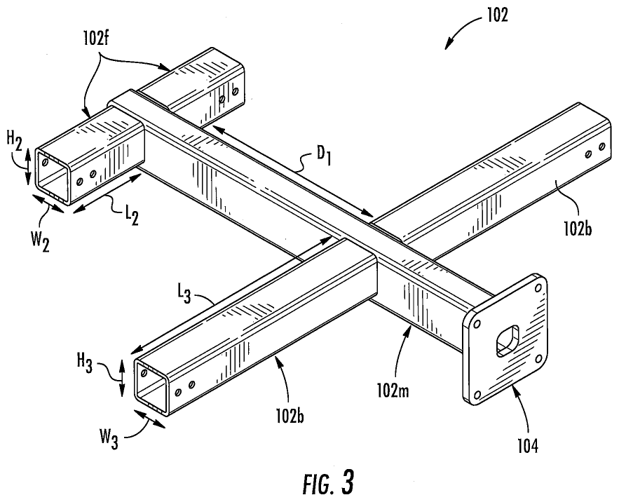

Referring now to FIGS. 3-6, in some embodiments, the frame 102 of the platform 100 comprises an elongated, hollow main support member 102m with a rectangular cross-section. The main support member 102m has a length (L₁), a width (W₁), and a height (H₁). In some embodiments, the main support member 102m has a length (L₁) in the range of about 40 inches to about 60 inches. In some embodiments, the main support member 102m has a width (W₁) in the range of about 2 inches to about 4 inches. In some embodiments, the main support member 102m has a height (H₁) in the range of about 4 inches to about 8 inches. In some embodiments, the main support member 102m has a height (H₁) that is greater than its width (W₁) (i.e., H₁>W₁). For example, in some embodiments, the main support member 102m has height (H₁) in the range of about 4 inches to about 8 inches and a width (W₁) in the range of about 2 inches to about 4 inches. In some embodiments, the main support member 102m has a height-to-width ratio of about 2:1.

Still referring to FIGS. 3-6, in some embodiments, the frame 102 of the platform 100 further comprises a plurality of auxiliary support members 102b, 102f. Each auxiliary support member 102b, 102f has a length (L₂, L₃), a width (W₂, W₃) (or diameter), and a height (H₂, H₃). The plurality of auxiliary support members 102b, 102f are attached orthogonally to the main support member 102m. In some embodiments, the auxiliary support members 102b, 102f have an elongate and hollow shape. The auxiliary support members 102b, 102f may have different cross-sectional shapes, such as, for example, square, circular, elliptical, rectangular, “L” angle, “C” channel, “C” purlin, or “Z” purlin, or the like. In some embodiments, the plurality of auxiliary support members 102b, 102f have a square or circular cross-section.

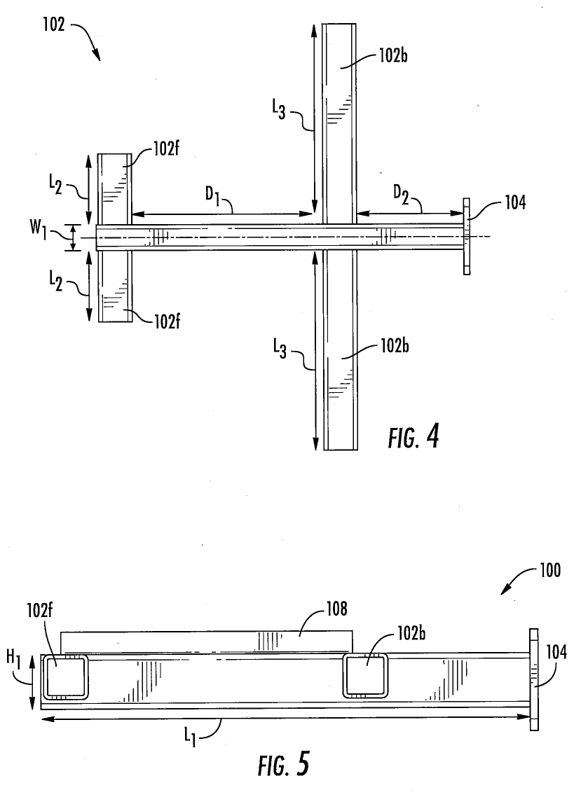

In some embodiments, the plurality of auxiliary support members 102b, 102f includes at least two front auxiliary support members 102f and at least two back auxiliary support members 102b. The front auxiliary support members 102f are longitudinally spaced apart from the back auxiliary support members 102b a distance (D₁) along the length (L₁) of the main support member 102m. In some embodiments, D₁ is in the range of about 20 inches to about 30 inches. In some embodiments, the combined length of the front auxiliary support members 102f is less than the combined length of the back auxiliary support members 102b, i.e., (L₂+L₂)<(L₃+L₃) (see, e.g., FIG. 4). For example, in some embodiments, the front auxiliary support members 102f have a combined length in the range of about 20 inches to about 30 inches and the back auxiliary support members 102b have a combined length in the range of about 40 inches to about 60 inches.

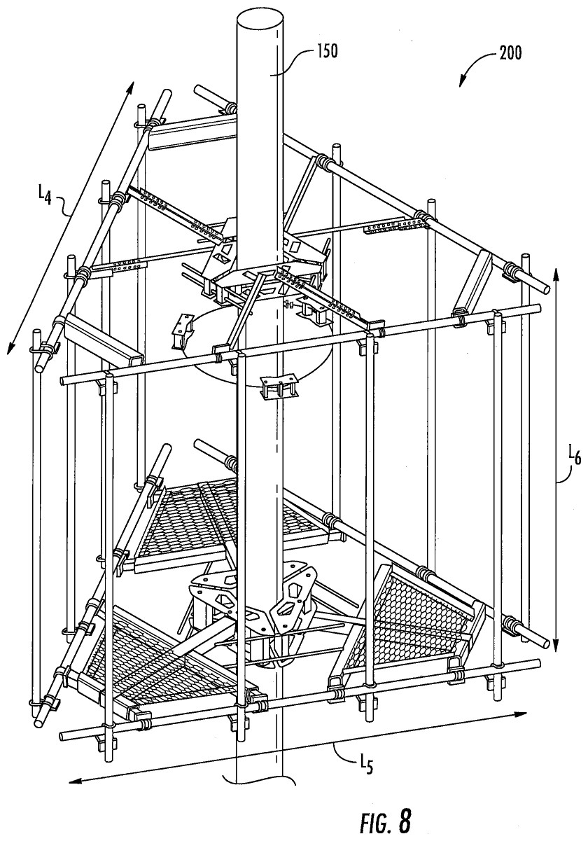

As shown in FIGS. 2-6, the high capacity platform 100 may further comprise a mounting plate 104. The mounting plate 104 may be coupled to an end of the main support member 102m. In some embodiments, the mounting plate 104 is configured to be mounted to a mounting structure (e.g., mounting bracket 230b) (see, e.g., FIG. 7). In some embodiments, the mounting bracket 230b is part of a cage mount 210 (FIG. 7).

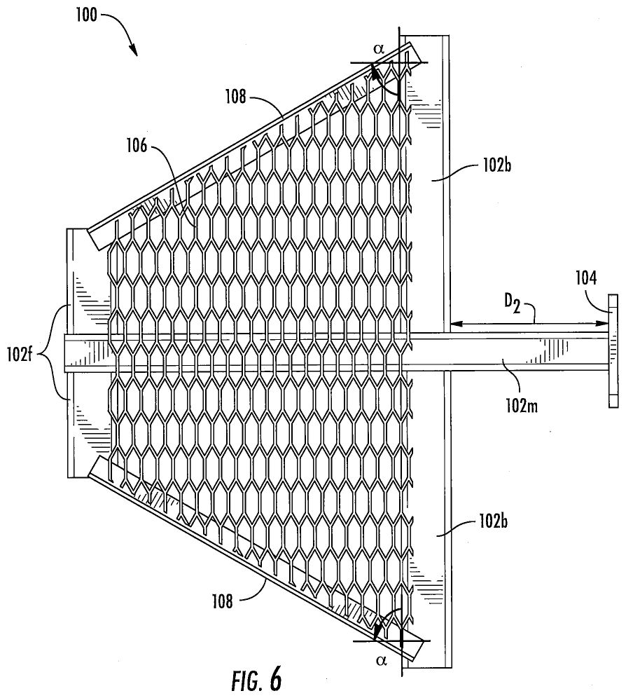

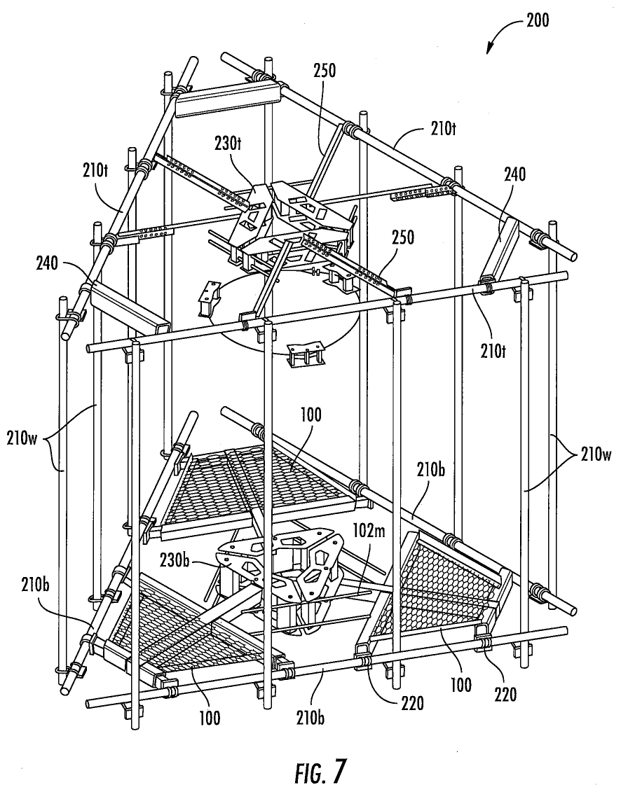

As shown in FIG. 4 and FIG. 6, in some embodiments, the back auxiliary support members 102b are longitudinally spaced apart from the mounting plate 104 a distance (D₂) along the length (L₁) of the main support member 102m. For example, in some embodiments, D₂ is in the range of about 10 inches to about 30 inches.

As shown in FIG. 2 and FIG. 6, the high capacity platform 100 may further comprise at least two grating edge members 108. The at least two grating edge members 108, which are shown having bent, L-shaped cross-sections, are coupled to the back and front auxiliary support members 102b, 102f. In some embodiments, the platform 100 further comprises a grating 106 coupled to the at least two grating edge members 108. The grating 106 may be supported by the two grating edge members 108, the auxiliary support members 102b, 102f, and the main support member 102m, thereby providing a work platform 100 for a technician to stand.

The grating 106 may have a trapezoidal shape as shown or may be configured in any other shape depending on the design of the frame 102 of the platform 100. The grating 106 may be configured as a steel mesh or other material having sufficient strength to support a technician and providing good traction to minimize slippage.

As discussed above, in some embodiments, the combined length of the front auxiliary support members 102f may be less than the combined length of the back auxiliary support members 102b (FIG. 4). As shown in FIG. 6, in some embodiments, to attach the grating edge members 108 to the front and back auxiliary support members 102b, 102f, the grating edge members 108 may be angled inwardly toward the main support member 102m relative to a longitudinal axis of the back auxiliary support members 102b. For example, in some embodiments, the grating edge members 108 may be attached at an angle (a) in a range of about 20 degrees to about 60 degrees relative to a longitudinal axis of the back auxiliary support members 102b.

Unlike known platforms or standoffs that have square or round support members, the high capacity platform 100 utilizes a rectangular support member having a greater height to width ratio than the platforms or standoffs in the prior art. This arrangement allows the platform 100 to support heavier vertical load weights than prior platforms with support members of similar weight and/or to support the same vertical loads with lighter support members that utilize less material.

Referring now to FIGS. 7-8, a high capacity cage mount assembly 200 according to some embodiments of the present invention is illustrated. The high capacity cage mount assembly 200 may comprise a cage mount 210, a plurality of top mounting brackets 230t, a plurality of bottom mounting brackets 230b, and a plurality of platforms 100. The platforms 100 are the same high capacity platforms 100 described above. In some embodiments, the cage mount assembly 200 may further comprise a plurality of support braces 240, 250. In some embodiments, the cage mount assembly 200 may comprise three platforms 100.

Referring to FIG. 7, in some embodiments, the cage mount 210 of the cage mount assembly 200 may comprise at least three top pipes 210t, each having a length (L₄), at least three bottom pipes 210b, each having a length (L₅), and a plurality of sidewall pipes 210w, each having a length (L₆) (see also, e.g., FIG. 8). The top pipes 210t are oriented such that each top pipe 210t is coupled to two other top pipes 210t. The bottom pipes 210b are similarly oriented such that each bottom pipe 210b is coupled to two other bottom pipes 210b. The sidewall pipes 210w are spaced apart from each other and are each orthogonally coupled to a respective top and bottom pipe 210t, 210b such that the top, bottom, and sidewall pipes 210t, 210b, 210w form a cage-like enclosure that can surround a mounting structure 150 (see, e.g., FIG. 8).

In some embodiments, the top pipes 210t have a length (L₄) in the range of about 8 feet to about 15 feet, the bottom pipes 210b have a length (L₅) in the range of about 8 feet to about 15 feet, and the sidewall pipes 210w have a length (L₆) in the range of about 6 feet to about 11 feet.

Still referring to FIG. 7, in some embodiments, the top pipes 210t may be secured to each other by support brackets 240. The top pipes 210t may be further secured to the top mounting brackets 230t by support braces 250. Each support brace 250 may extend between and be coupled to a top pipe 210t and a respective top mounting bracket 230t. The top mounting brackets 230t are configured to be secured to a mounting structure 150 (see, e.g., FIG. 8).

The auxiliary support members 102b, 102f of each platform 100 are configured to be secured to a least two of the bottom pipes 210b of the cage mount 210. The mounting plate 104 of each platform 100 is configured to be secured to a respective bottom mounting bracket 230b. The bottom mounting brackets 230b are configured to be secured to a mounting structure 150 (see, e.g., FIG. 8).

Referring now to FIG. 8, the top and bottom mounting brackets 230t, 230b may secure the high capacity cage mount assembly 200 to a mounting structure 150. In some embodiments, the mounting structure 150 is a monopole antenna. In some embodiments, the cage mount assembly 200 is configured to be mounted to a mounting structure 150 having a diameter in the range of about 12 inches to about 50 inches. The high capacity cage mount assembly 200 can provide space under an antenna to work while also providing a work platform 100 for a technician. In some embodiments, the high capacity cage mount assembly 200 is configured to support a load weight of about 100 pound to about 5300 pounds.

The foregoing is illustrative of the present invention and is not to be construed as limiting thereof. Although exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

That which is claimed is:

1. A high capacity platform, the platform comprising:
a frame, the frame comprising:
an elongate, hollow main support member of rectangular cross-section, the main support member having a length, a width, and a height; and
a plurality of elongate, hollow auxiliary support members attached orthogonally to the main support member, each auxiliary support member having a length, a width, and a height;
a mounting plate coupled to an end of the main support member;
at least two grating edge members coupled to the auxiliary support members; and
a grating, wherein the grating is supported by the two grating edge members, the auxiliary support members, and the main support member.

2. The high capacity platform of claim 1, wherein the main support member has a length in the range of about 40 inches to about 60 inches, a width in the range of about 2 inches to about 4 inches, and a height in the range of about 4 inches to about 8 inches.

3. The high capacity platform of claim 1, wherein the plurality of auxiliary support members have a square or circular cross-section.

4. The high capacity platform of claim 1, wherein the main support member has a greater height than width.

5. The high capacity platform of claim 4, wherein the main support member has a height in the range of about 4 inches to about 8 inches and a width in the range of about 2 inches to about 4 inches.

6. The high capacity platform of claim 1, wherein the main support member has a height-to-width ratio of about 2:1.

7. The high capacity platform of claim 1, wherein the plurality of auxiliary support members include at least two front auxiliary support members and at least two back auxiliary support members, the at least two front auxiliary support members being spaced apart from the at least two back auxiliary support members a distance longitudinally along the length of the main support member.

8. The high capacity platform of claim 5, wherein the combined length of the at least two front auxiliary support members is less than the combined length of the at least two back auxiliary support members.

9. The high capacity platform of claim 1, wherein the platform is formed of a weldment.

10. The high capacity platform of claim 1, wherein the platform comprises galvanized steel.

11. The high capacity platform of claim 1, wherein the mounting plate is configured to be mounted to a mounting structure.

12. The high capacity platform of claim 9, wherein the mounting structure is a cage mount.

13. The high capacity platform of claim 1, wherein the grating edge members are angled relative to a longitudinal axis of the back auxiliary support members.

14. The high capacity platform of claim 12, wherein the grating edge members are each at an angle in a range of about 20 degrees to about 60 degrees.

15. The high capacity platform of claim 1, wherein the platform is configured to support a load weight of about 100 pound to about 3600 pounds.

16. A high capacity cage mount assembly, comprising:
(a) a cage mount, the cage mount comprising:
(i) at least three top pipes, wherein the top pipes are oriented such that each top support pipe is coupled to two other top pipes;
(ii) at least three bottom pipes, wherein the bottom pipes are oriented such that each bottom pipe is coupled to two other bottom pipes; and
(iii) a plurality of spaced apart sidewall pipes, each sidewall pipe being orthogonally attached to a respective top and bottom pipe such that the top, bottom and sidewall pipes form a cage-like enclosure;
(b) a plurality of platforms, each platform comprising:
(i) a frame, the frame comprising:
(1) an elongate, hollow support member of rectangular cross-section, the main support member having a length, a width, and a height; and
(2) a plurality of elongate, hollow auxiliary support members attached orthogonally to the main support member, each auxiliary support member having a length, a width, and a height;
(ii) a mounting plate coupled to an end of the main support member;
(iii) at least two grating edge members coupled to the auxiliary support members; and
(iv) a grating, wherein the grating is supported by the two grating edge members, the auxiliary support members, and the main support member; and
(c) a plurality of top mounting brackets configured to be secured to a mounting structure;
(d) a plurality of support braces, each support brace extending between and coupled to a top pipe and a top mounting bracket; and
(e) a plurality of bottom mounting brackets configured to be secured to the mounting structure,
wherein the auxiliary support members of each platform are configured to be secured to at least two of the bottom pipes of the cage mount and the mounting plate of each platform is configured to be secured to a respective bottom mounting bracket.

17. The high capacity cage mount assembly of claim 16, wherein the cage mount assembly comprises three platforms.

18. The high capacity cage mount assembly of claim 16, wherein the mounting structure is a monopole antenna.

19. The high capacity cage mount assembly of claim 16, wherein each sector of the cage mount assembly is configured to support a total vertical load of up to about 5300 pounds.

20. A high capacity platform assembly, the platform assembly comprising:
a mounting structure; and
at least three high capacity platforms, each platform comprising:
a frame, the frame comprising:
an elongate, hollow main support member of rectangular cross-section, the main support member having a length, a width, and a height; and
a plurality of elongate, hollow auxiliary support members attached orthogonally to the main support member, each auxiliary support member having a length, a width, and a height;
a mounting plate coupled to an end of the main support member and configured to be secured to the mounting structure;
at least two grating edge members coupled to the auxiliary support members; and
a grating, wherein the grating is supported by the two grating edge members, the auxiliary support members, and the main support member,
wherein each platform is secured to the mounting structure by the mounting plate.
